(19) United States
(12) Patent Application Publication
(10) Pub. No.: US 2021/0174335 A1
(43) Pub. Date: Jun. 10, 2021

(54) SIMPLE ORDER PAYMENT SYSTEM AND METHOD FOR OMNI-CHANNEL SHOPPING

(71) Applicant: CREFUN CO., LTD., Mokpo-si (KR)

(72) Inventor: Ji Woong LEE, Jeollanam-do (KR)

(73) Assignee: CREFUN CO., LTD,, Mokpo-si (KR)

(21) Appl. No.: 17/081,775

(22) Filed: Oct. 27, 2020

(30) Foreign Application Priority Data
Dec. 9, 2019 (KR) 10-2019-0162645

(51) Int. Cl. G06Q 20/32; G06Q 20/10

(52) U.S. Cl. CPC G06Q 20/3278; G06Q 20/102; G06Q 20/3276

(57) ABSTRACT

A simple order payment system for omni-channel shopping includes a terminal of a consumer configured to select a product by reading a QR code or RFID tag of the product at an offline store or an online shopping mall equivalent thereto, a store server constructed in the offline store and configured to operate in conjunction with a mobile app activated by recognizing a unique digital number of the offline store contained in the QR code or RFID tag read from the terminal, a payment server configured to identify orderer information on the selected product through a monitor of the store server and to perform payment processing on the ordered product, and an AI approval unit configured to intelligently perform approval for the payment processing, by identifying the authenticity of the consumer through a “consumer's general personal identity information” database (DB) for safe payment in the payment server.

### BACKGROUND

### 1. Technical Field

The present disclosure relates to a simple order payment system and method for omni-channel shopping, and more particularly, to a simple order payment system and method for omni-channel shopping, which enable a product to be conveniently delivered to a destination by only reading a QR code, indicated in the product to be purchased, through a terminal without a wait process for separate payment processing in purchasing the product at an offline store.

### 2. Related Art

In general, when people try to visit an offline store, for example, a hypermarket or a shopping center and purchase products, they have to frequently stand and wait in a long line for payment processing in the state in which they have selected the products.

Furthermore, such a wait time for payment processing may act, as a great burden and stress, on customers who are busy settling their other affairs. If payment processing is further delayed, a customer may give up a purchasing decision for a product and visit another store where payment processing can be rapidly performed.

In particular, in the case of an online shopping mall managed in the equivalent manner to an offline store, in a process for a consumer to select a product and to pay for the product using his/her personal terminal, there is a problem in that a hacker intercepts a certification number by generating an error upon SMS certification, certification using an authentication certificate, ARS certification, or certification using an OTP through a malcode installed in the personal terminal. Accordingly, personal information leakage is very serious.

Moreover, if information on a person is leaked to a hacker, the person may suffer a pecuniary loss due to the payment made by the other persons, although the person has not directly performed payment processing. Such personal information is also used for a method using another piece of marketing means.

Accordingly, there is an urgent need to develop improved technologies capable of solving such problems.

### Prior Art Document

### Patent Document

(Patent Document 0001) Korean Patent Application Publication No. 10-2013-0084274 [entitled “3-dimensinal Virtual Reality Shopping Mall”]

### SUMMARY

Various embodiments are directed to providing a simple order payment system and method for omni-channel shopping, which enable a person to receive an article at his or her desired destination by only selecting the article without the need to stand and wait in a long line for payment processing related to the article to be purchased in an online shopping mall or an offline store equivalent thereto and improve the reliability of e-commerce by guaranteeing the safety of payment in an article purchase process in an online shopping mall.

In an embodiment, a simple order payment system for omni-channel shopping may include a terminal of a consumer configured to select a product by reading a QR code or RFID tag of the product sold at an offline store or an online shopping mall equivalent thereto, a store server constructed in the offline store and configured to operate in conjunction with a mobile app activated by recognizing a unique digital number of the offline store contained in the QR code or RFID tag read from the terminal, a payment server configured to identify orderer information on the selected product through a monitor of the store server and to perform payment processing on the ordered product, and an artificial intelligence (AI) approval unit configured to intelligently perform approval necessary for the payment processing by identifying the authenticity of the consumer through a “consumer's general personal identity information” database (DB) for safe payment in the payment server.

In an example of the simple order payment system, a beacon is further constructed and installed in the offline store.

In an example of the simple order payment system, the beacon detects information on the terminal when the terminal reads the QR code or RFID tag of the product provided at the offline store, and transmits the information to the store server.

In an example of the simple order payment system, the store server transmits the mobile app to the terminal when receiving the information on the terminal from the beacon.

In an example of the simple order payment system, the payment server determines whether the orderer information obtained from the mobile app is identical with the information on the terminal received from the beacon, performs the payment processing on the selected product when the orderer information and the information on the terminal are determined to be identical, and performs the payment processing by performing “mutual question inducement and answers” provided by the AI approval unit.

In an embodiment, a simple order payment method for omni-channel shopping may include steps of a) selecting, by a terminal of a consumer, a product, provided in an offline store, b) intercepting, by a beacon constructed in the offline store, information on the terminal and transmitting the information to a store server, c) identifying orderer information of the selected product based on the information on the terminal through a monitor of the store server, and d) performing, by a payment server, payment processing on the selected product.

In an example of the simple order payment method, the step d) may include a step d′) of intelligently performing, by an artificial intelligence (AI) approval unit, approval necessary for the payment processing by identifying the authenticity of the consumer through a “consumer's general personal identity information” database (DB) for safe payment in the payment server.

In an example of the simple order payment method, at the step b), the beacon detects information on the terminal when the terminal reads a QR code or RFID tag of the product and transmits the information to the store server, the store server transmits a mobile app to the terminal when receiving the information on the terminal from the beacon, and the QR code contains a unique digital number of the offline store.

### BRIEF DESCRIPTION OF THE DRAWINGS

FIG. 1 is a schematic diagram illustrating a configuration of an order payment system for simple omni-channel shopping according to an embodiment of the present disclosure.

FIG. 2 is a diagram illustrating, as a simple concept, the state in which the elements of the order payment system perform payment processing through the mutual question inducement and answers of an AI approval unit 400.

FIG. 3 is a block diagram illustrating, as a simple concept, a communication method through a communication window 410 of the AI approval unit 400 of FIG. 2.

FIG. 4 is a flowchart sequentially illustrating an order payment method for simple omni-channel shopping according to an embodiment of the present disclosure.

### DETAILED DESCRIPTION

The present disclosure should be interpreted as including even the scope of a right to a technical spirit through various modified embodiments. The embodiments are provided only to complete the present disclosure and to allow those skilled in the art to fully understand the category of the present disclosure. The present disclosure is only defined by the category of the claims.

Moreover, it is to be noted that drawings related to a prior art are omitted because the technical spirit of the present disclosure may be understood by the detailed description of the present disclosure. It is to be noted that a product and an article among terms to be described later have the same meaning and may be interchangeably used according to circumstances.

The term “product and article” described in the present disclosure may be interchangeably described and may be interpreted as terms having the same meaning. A simple order payment system and method for omni-channel shopping according to an embodiment of the present disclosure will be described in detail as follows.

An omni-channel is a term in which “omni” meaning all and a “channel” meaning a distribution channel are combined, and is generally used as a meaning that all channels are used.

That is, the omni-channel indicates a service which enables a consumer to search for and purchase an article (or service) through various channels, such as online, offline, and a mobile. The omni-channel may provide a shopping environment in which characteristics of distribution channels are combined so that a consumer can feel as if he or she uses the same store through any channel.

A wireless Internet technology may include a wireless LAN, Wi-Max, WiBro, IEEE, Wi-Fi, Bluetooth, REID, ZigBee, ultrasonic communication, BLE, etc. A wired communication technology may include power line communication, USB communication, Ethernet, serial communication, an optical/coaxial cable, etc.

A communication unit may include technical standards or communication methods for mobile communication (e.g., a global system for mobile communication (GSM), code division multi access (CDMA), code division multi access 2000 (CDMA2000), enhanced voice-data optimized or enhanced voice-data only (EVDO), wideband CDMA (WCDMA), high speed downlink packet access (HSDPA), high speed uplink packet access (HSUPA), long term evolution (LTE), and long term evolution-advanced (LTE-A)).

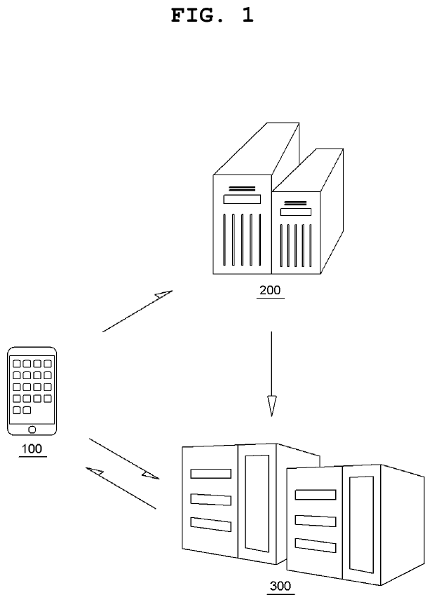

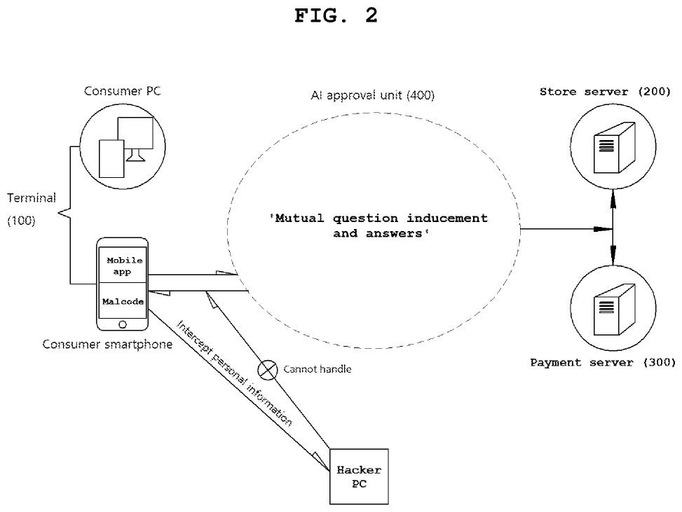

The simple order payment system for omni-channel shopping according to an embodiment of the present disclosure may be used to implement the transmission of data based on the technical bases of the wireless Internet technology and the communication unit. For example, the simple order payment system may be configured to include a terminal 100 of a consumer who selects a product by reading a QR code of the product provided in a hypermarket or shopping center, that is, an example of an offline store, a store server 200 constructed in the offline store and configured to operate in conjunction with a mobile application (hereinafter referred to as a “mobile app”) activated by recognizing a unique digital number of the offline store contained in the QR code read from the terminal, a payment server 300 configured to identify orderer information on the selected product through a monitor of the store server and to perform payment processing on the ordered product, and an artificial intelligence (AI) approval unit 400 configured to intelligently perform approval necessary for the payment processing by identifying the authenticity of the consumer through a consumer's general personal identity database (DB) for the safe payment in the payment server. For this configuration, reference may be made to the drawings illustrated in FIGS. 1 and 2.

The store server 200 may provide a supermarket or a shopping center, that is, an offline store, in the form of an online shopping mall service on the Internet. The online shopping mall may have a website form or a cloud platform form. The online shopping mall may be interpreted to include all forms which do not specially affect the operation of a shopping mall through Internet access.

The QR code contains a unique digital number of an offline store in addition to unique numbers of products, which are provided in an online shopping mall to the offline store and are equivalent to products provided in the offline store. When the QR code is read by the terminal 100 of a consumer, the store server 200 constructed to operate the offline store and the online shopping mall together based on the unique digital number contained in the QR code may induce the terminal 100 of the consumer to install a mobile app by transmitting the mobile app to the terminal 100 of the consumer that has read the QR code.

The unique digital number of the offline store contained in the QR code may be detected by a beacon constructed in the offline store through wireless communication with the terminal 100. In this case, the beacon may intercept information on the terminal 100 based on the detected unique digital number, and may transmit the information to the store server 200.

Accordingly, the store server 200 may transmit the mobile app to the terminal 100 of the consumer based on the information on the terminal 100 received from the beacon.

When the mobile app transmitted to and installed in the terminal 100 of the consumer is activated, the orderer information on the selected product contained in a shopping basket may be identified through the monitor of the store server 200.

The terminal 100 may be configured as the personal PC or personal portable terminal of a user, that is, a consumer, as in FIG. 1, for example. In particular, according to an embodiment of the present disclosure, a smartphone capable of an online order using the Internet network, such as 3G, LTE, or 5G, may be used as the personal portable terminal.

Such orderer information may include the unique number of a model name of the terminal 100 that reads a QR code or an RFID tag, the name, contact address, and destination address of a consumer, for example, as identity-related information on the consumer, that is, the owner of the terminal 100, and one or more pieces of payment information, among micropayment information, card payment information, account payment information, and card point payment information, for example, as payment information for a product.

The orderer information identified through the monitor of the store server 200 as described above is transmitted to the payment server 300. When it is determined that the orderer information is identical with the information on the terminal 100 of the consumer, the payment server 300 may perform the payment processing on the selected product using payment information on the consumer based on the orderer information.

When the payment server 300 performs the payment processing, the consumer can identify the contents of the payment processing through the terminal 100 of the consumer because information related to the payment processing details of the product is transmitted to the terminal 100 of the consumer.

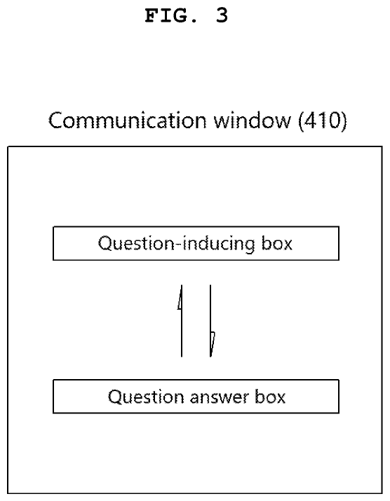

In particular, the payment server 300 may perform payment processing only when receiving approval, necessary for the payment processing, from the AI approval unit 400 in a payment processing process for a product. For safe payment processing of the payment server, the AI approval unit 400 provides the terminal 100 of the consumer with a communication window 410 for identifying the authenticity of the consumer, in the approval process as in FIG. 3, and also determines whether to transmit approval by identifying the authenticity of the consumer through a web communication form “mutual question inducement and answers” based on “consumer's general personal identity information.”

The AI approval unit 400 transmits the web communication form “mutual question inducement and answers” to the terminal 100 of the consumer and determines the authenticity of the consumer by analyzing the contents of answers received through “mutual question inducement and answers”, which is installed in the terminal 100 of the consumer, based on the “consumer's general personal identity information.”

The consumer's general personal identify information refers to a massive amount of personal information left online by a consumer through electronic behaviors. The examples thereof may include an ID, a password, an address, a social security number, an academic background, a network of friends, and other personal information. The AI approval unit 400 may learn, accumulate and store such personal information in a “consumer's general personal identity information” DB form.

The AI approval unit 400 accumulates knowledge information on a consumer to an extent equivalent to knowledge information on the identity of the consumer. Accordingly, the contents of answers received through the “mutual question inducement and answers” provided from the AI approval unit 400 to the terminal 100 of the consumer in an approval process for payment cannot be handled by personal information intercepted through a malcode of a hacker. Accordingly, it is possible to prevent a problem of payment approval through the interception of personal information, which occurs in the existing SMS certification, certification using an authentication certificate, ARS certification, or OTP payment approval. As a result, the safety of payment can be guaranteed.

The method “mutual question inducement and answers” is a method in which the AI approval unit 400 provides the terminal 100 of the consumer with questions, which induce answers for determining the authenticity of the consumer, several times and the consumer answers the questions, provided through the terminal 100, several times.

If the consumer determines that a question, which induces an answer and is provided by the AI approval unit 400, is not suitable, the consumer may request, through the terminal 100, the AI approval unit 400 to provide a question that induces an answer. The AI approval unit 400 can give an answer to the request for the question. Accordingly, communication necessary for payment approval can be performed between both parties.

As described above, the AI approval unit 400 determines the authenticity of the consumer based on the “consumer's general personal identity information” DB that has already learnt the contents of answers transmitted through the web communication form called “mutual question inducement and answers.”

In particular, the AI approval unit 400 may isolate and control a network of a terminal. Although a hacker remotely accesses a certification terminal and intercepts certification information, the contents of answers received through the web communication form “mutual question inducement and answers” cannot be handled by intercepted personal information of the hacker, thereby invalidating key logging hacking by the hacker.

That is, the web communication form “mutual question inducement and answers” requests the contents of answers that proves a consumer himself or herself in such a manner that the AI approval unit 400 provides the terminal 100 with questions for various types of personal information which the consumer knows the best and can prove the consumer. Accordingly, questions for various types of personal information for proving a consumer himself or herself, requested through the web communication form “mutual question inducement and answers”, cannot be handled by personal information intercepted by key logging hacking using a malcode, thereby inevitably invalidating the personal information intercepted by key logging hacking.

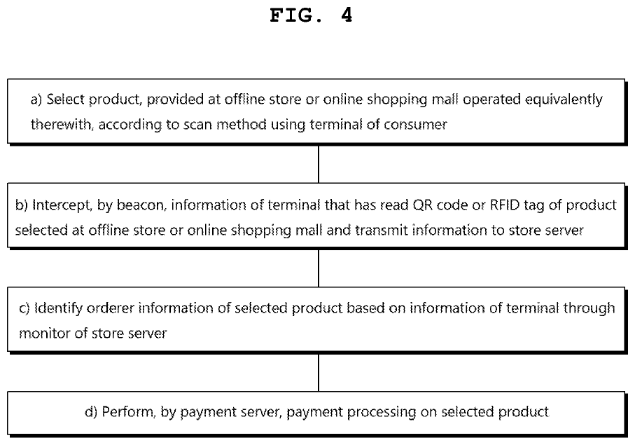

As illustrated in FIG. 4, a simple order payment method for omni-channel shopping according to an embodiment of the present disclosure may be configured to include steps of a) selecting, by the terminal 100 of a consumer, a product, provided in an offline store or an online shopping mall managed in an equivalent manner to the offline store, according to a scan method, b) intercepting, by the beacon, information on the terminal 100 that has read the QR code or RFID tag of the product selected at the offline store or the online shopping mall and transmitting the information to the store server 200, c) identifying orderer information on the selected product based on the information on the terminal 100 through the monitor of the store server 200, and d) performing, by the payment server 300, payment processing on the selected product, with reference to FIGS. 1 to 3.

The step a) of selecting, by the terminal 100 of a consumer a product, provided at an offline store or an online shopping mall managed in an equivalent manner thereto, according to a scan method is a process in which a consumer visits an offline store or an online shopping mall and selects a product to be purchased, by reading a QR code or an RFID tag, indicated in the product, using the terminal 100 of the consumer.

The step b) of intercepting, by the beacon, information on the terminal 100 that has read the QR code or RFID tag of the product selected at the offline store or the online shopping mall and transmitting the information to the store server 200 is a process in which when the QR code or RFID tag of the product to be purchased is read by the terminal 100 of the consumer, information on the terminal 100 is transmitted to the store server 200 through the beacon.

In this case, the beacon may intercept the information on the terminal 100 by detecting the information when the terminal 100 reads the QR code or RFID tag indicated in the product. In particular, the beacon may be used to rapidly and accurately perform wireless communication with other electronic devices within an offline store. The beacon can rapidly perform data communication within several meters, more precisely, several centimeters.

As described above, if the information on the terminal 100 intercepted by the beacon is wirelessly transmitted to the store server 200, the store server 200 transmits a mobile app to the terminal 100 of the consumer based on the information on the terminal 100 received from the beacon. The mobile app transmitted to the terminal 100 incorporates orderer information therein in a process of being installed in the terminal 100 and activated.

In particular, an online shopping mall managed in an equivalent manner to an offline store is registered and associated with portal sites (e.g., Naver, Daum, and Amazon), SNS (e.g., Twitter and Facebook), and cloud platforms, for example, according to a mobile webpage form, which makes it possible to provide marketing services for products through the portal sites, SNS (e.g., Twitter and Facebook), and the cloud platforms in addition to the online shopping mall itself. Accordingly, consumers can purchase products, provided in the online shopping mall, in various ways through the portal sites, the SNS, and the cloud platforms.

The online shopping mall may also be managed in a mobile webpage form in order to obviate inconvenience in web surfing through the terminal 100. To this end, a browsing technology for a mobile version may be applied to a mobile webpage so that the webpage can be viewed even on a device screen of the terminal 100. The terminal 100 may generally refer to a device capable of Internet access. According to an embodiment of the present disclosure, a smartphone is suitable for the terminal 100.

The step c) of identifying orderer information on the selected product based on the information on the terminal 100 through the monitor of the store server 200 is a process of identifying the orderer information, incorporated through the mobile app, through the monitor of the store server 200.

Such orderer information may include any one piece of payment information, among micropayment information, card payment information, account payment information, and card point payment information, as payment information for a product, in addition to the unique number of a model name of the terminal 100 that has read a QR code or an RFID tag and the name, contact address, and destination address of a consumer, for example, as identity-related information on the consumer, that is, the owner of the terminal 100.

In particular, the mobile app is a mobile-dedicated app that enables the payment server 300 to perform certification processing and payment processing in such a manner that order information and payment means are received from a mobile webpage of an online shopping mall and payment processing is performed.

The step d) of performing, by the payment server 300, payment processing on the selected product is a process in which after the orderer information identified through the monitor of the store server 200 is transmitted to the payment server 300, when it is determined that the orderer information is identical with the information on the terminal 100 of the consumer, the payment server 300 performs payment processing on the selected product using payment information on the consumer, that is, the owner of the terminal 100 identical with the orderer information.

In this case, the orderer information identified through the monitor of the store server 200 is the orderer information incorporated through the mobile app that has been transmitted to the terminal 100 and activated. The information on the terminal 100 owned by the consumer is the information on the terminal detected and obtained by the beacon.

Accordingly, when it is determined that the orderer information obtained through the mobile app is identical with the information on the terminal 100 obtained from the beacon, the payment server 300 performs payment processing on the selected product based on the orderer information.

In particular, in the payment process of the payment server 300, a step d′) of intelligently performing, by the AI approval unit 400, approval necessary for the payment processing, by identifying the authenticity of the consumer based on “consumer's general personal identity information” for safe payment in the payment server may be further performed in order to strengthen security.

If the step d′) is performed, questions for various types of personal information that proves a consumer, requested through the web communication form “mutual question inducement and answers”, cannot be handled by personal information intercepted from the terminal 100 of the consumer, thereby invalidating the information intercepted by key logging hacking.

Moreover, the contents which are requested by a question-inducing box and an answer box illustrated in FIG. through the web communication form “mutual question inducement and answers”, may be provided several times. The contents of questions provided by the AI approval unit 400 through the question-inducing box of the communication window 410 may include various question pattern methods necessary to recognize the authenticity of a consumer himself or herself, by grafting a security channel generated based on a “virtualization-based network separation technology” onto the AI of the AI approval unit 400 that performs autonomous learning. Such various question pattern methods cannot be handled by only intercepted personal information.

The grafting of the “virtualization-based network separation technology” onto the AI technology fundamentally blocks or removes a hacker's behavior to remotely access a certification terminal and intercept certification information, by isolating and controlling a network of the certification terminal, or makes a hacker unable to handle various question pattern methods, obtained through intelligent learning of AI, although certification information is intercepted. In this case, a separate dedicated network (e.g., VPN) for transmitting only the certification information may be set up in order to exchange the certification information. An input method may also be automated in order to invalidate a key logging hacking method by a hacker.

When the payment server 300 performs payment processing, information related to the details of the payment processing for a product is transmitted to the terminal 100 owned by a consumer. The consumer can identify the details of the payment processing. The product for which the payment has been completed can be delivered to a destination address of the consumer provided through a terminal of a delivery person.

As described above, according to the present disclosure, it is possible to expect an effect in that a user can conveniently purchase and receive a product, provided at an offline store, without the need to wait for payment at the offline store by selecting the product in a way to read a QR code, indicated in the product, using a terminal.

Furthermore, according to the present disclosure, it is possible to expect effects in that the reliability of e-commerce is improved because the safety of payment is guaranteed in a process of purchasing an article in an online shopping mall and damage to consumers is prevented by invalidating the interception of personal information by a hacker.

While various embodiments have been described above, it will be understood to those skilled in the art that the embodiments described are by way of example only. Accordingly, the disclosure described herein should not be limited based on the described embodiments.

What is claimed is:

1. A simple order payment system for omni-channel shopping, comprising:
a terminal of a consumer configured to select a product by reading a QR code or RFID tag of the product sold at an offline store or an online shopping mall equivalent to the offline store;
a store server constructed in the offline store and configured to operate in conjunction with a mobile app activated by recognizing a unique digital number of the offline store contained in the QR code or RFID tag read from the terminal;
a payment server configured to identify orderer information on the selected product through a monitor of the store server and perform payment processing on the ordered product; and
an artificial intelligence (AI) approval unit configured to intelligently perform approval, necessary for the payment processing, by identifying the authenticity of the consumer through a “consumer's general personal identity information” database (DB) for safe payment in the payment server.

2. The simple order payment system of claim 1, wherein a beacon is further constructed and installed in the offline store.

3. The simple order payment system of claim 2, wherein the beacon detects information on the terminal when reading the QR code or RFID tag of the product, provided at the offline store, using the terminal and transmits the information to the store server.

4. The simple order payment system of claim 3, wherein the store server transmits the mobile app to the terminal when receiving the information on the terminal from the beacon.

5. The simple order payment system of claim 4, wherein the payment server determines whether the orderer information obtained from the mobile app is identical with the information on the terminal received from the beacon, performs the payment processing on the selected product when the orderer information and the information on the terminal are determined to be identical, and performs the payment processing by performing “mutual question inducement and answers” provided by the AI approval unit.

6. A simple order payment method for omni-channel shopping, comprising steps of:
a) selecting, by a terminal of a consumer, a product, provided in an offline store or an online shopping mall managed in an equivalent manner to the offline store, according to a scan method;
b) intercepting, by a beacon, information on the terminal that has read a QR code or RFID tag of the product selected at the offline store or the online shopping mall and transmitting the information to a store server;
c) identifying orderer information on the selected product based on the information on the terminal through a monitor of the store server; and
d) performing, by a payment server, payment processing on the selected product.

7. The simple order payment method of claim 6, wherein the step d) includes a step d′) of intelligently performing, by an artificial intelligence (AI) approval unit, approval, necessary for the payment processing, by identifying the authenticity of the consumer through a “consumer's general personal identity information” database (DB) for safe payment in the payment server.

8. The simple order payment method of claim 6, wherein:
at the step b), the beacon detects information on the terminal when the terminal reads the QR code or RFID tag of the product and transmits the information to the store server;
the store server transmits a mobile app to the terminal when receiving the information on the terminal from the beacon; and
the QR code contains a unique digital number of the offline store corresponding to the online shopping mall.
